(19) United States
(12) Patent Application Publication
(10) Pub. No.: US 2021/0055963 A1
(43) Pub. Date: Feb. 25, 2021

(54) WAKE DETECTION AT CONTROLLER FOR PHYSICAL LAYER OF SINGLE PAIR ETHERNET NETWORK, AND RELATED SYSTEMS, METHODS AND DEVICES

(71) Applicant: Microchip Technology Incorporated, Chandler, AZ (US)

(72) Inventors: Hongming An, San Diego, CA (US); John Junling Zang, Shenzhen (CN); Henry Liang, Shenzhen (CN); Thor Xia, Futian (CN); Congqing Xiong, Luohu dsitrict (CN)

(21) Appl. No.: 16/591,294

(22) Filed: Oct. 2, 2019

(30) Foreign Application Priority Data
Aug. 23, 2019 (CN) 201910784580.0

(51) Int. Cl. G06F 9/50; G06F 1/324; H04L 12/40; G06F 1/3209; H04L 12/10

(52) U.S. Cl. CPC G06F 9/505; G06F 1/324; H04L 12/10; G06F 1/3209; H04L 12/40039

(57) ABSTRACT

Circuitry for detecting valid signals on a single pair Ethernet bus and related systems are described. Also described are circuits and related systems for wake detection at a physical layer of a network segment, and in some embodiments, wake detection circuitry may include, or use, the signal detection circuitry. In some cases, a low frequency clock generator may be used to clock wake detection circuitry, including during low power modes of operation. In some cases, the low frequency clock generator may be enabled or disabled, selectively, to limit power consumption.

### PRIORITY CLAIM

This application claims the benefit of the filing date of Chinese Provisional Patent Application Serial No. 201910784580.0, filed Aug. 23, 2019, for “WAKE DETECTION AT CONTROLLER FOR PHYSICAL LAYER OF SINGLE PAIR ETHERNET NETWORK, AND RELATED SYSTEMS, METHODS AND DEVICES.”

### TECHNICAL FIELD

Embodiments described herein related, generally, to single pair Ethernet, and more specifically, some embodiments relate to systems, methods and devices for wake detection at a physical layer of a network segment.

### BACKGROUND

Interconnects are widely used to facilitate communication among devices of a network. Generally speaking, electrical signals are transmitted on a physical medium (e.g., a bus, a coaxial cable, or a twisted pair—and sometimes referred to simply as a “line”) by the devices coupled to the physical medium.

According to the Open Systems Interconnection model (OSI model), Ethernet-based computer networking technologies use baseband transmission (i.e., electrical signals are discrete electrical pulses) to transmit data packets and ultimately messages that are communicated among network devices. According to the OSI model, specialized circuitry called a physical layer (PHY) device or controller is used to interface between an analog domain of a line and a digital domain of a data link layer (or just “link layer”) that operates according to packet signaling. While a data link layer may include one or more sublayers, in Ethernet-based computer networking, a data link layer typically includes at least a media access control (MAC) layer that provides control abstraction of the physical layer. By way of example, when transmitting data to another device on a network, a MAC controller may prepare frames for the physical medium, add error correction elements, and implement collision avoidance. Further, when receiving data from another device, a MAC controller may ensure integrity of received data and prepare frames for higher layers.

There are various network topologies that implement physical layers and link layers (and may include other layers, without limitation). The Peripheral Component interconnect (PCI) standard and the Parallel Advanced Technology Attachment (Parallel ATA), both around since the early 1990's, may implement a multi-drop bus topology. The trend since the early 2000's has been to use point-to-point bus topologies, for example, the PCI Express standard and the Serial ATA (SATA) standard implement point-to-point topologies.

A typical point-to-point bus topology may implement lines between each device (e.g., dedicated point-to-point) or lines between devices and switches (e.g., switched point-to-point, without limitation). In a multi-drop topology, a physical medium is a shared bus and each network device is coupled to the shared bus, for example, via a circuit chosen based on the type of physical medium (e.g., coaxial or twisted pair, without limitation).

Point-to-point bus topologies, such as a dedicated point-to-point topology or a switched point-to-point topology, require more wires and more expensive material than multi-drop topologies due, in part, to the greater number of links between devices. In certain applications, such as automotive, there may be physical constraints that make it difficult to directly connect devices, and so a topology that does not require, or does not require as many, direct connections (e.g., a multi-drop topology, without limitation) in a network or a sub-network may be less susceptible to such constraints.

Devices that are on a baseband network (e.g., a multi-drop network without limitation) share the same physical transmission medium, and a typically use the entire bandwidth of that medium for transmission (stated another way, a digital signal used in baseband transmission occupies the entire bandwidth of the media). As a result, only one device on a baseband network may transmit at a given instant.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 illustrates a network segment in accordance with one or more embodiments.

FIG. 2 illustrates a system in accordance with one or more embodiments.

FIG. 3 illustrates a sleep mode controller in accordance with one or more embodiments.

FIG. 4 illustrates a process in accordance with one or more embodiments.

FIG. 5 illustrates a timing diagram in accordance with one or more embodiments.

FIG. 6 illustrates a timing diagram in accordance with one or more embodiments.

FIG. 7 illustrates a signal detection circuit in accordance with one or more embodiments.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

A vehicle, such as an automobile, a truck, a bus, a ship, and/or an aircraft, may include a vehicle communication network. The complexity of a vehicle communication network may vary depending on a number of electronic devices and subsystems within the network. For example, an advanced vehicle communication network may include various control modules for, for example, engine control, transmission control, safety control (e.g., antilock braking), and emissions control. As another non-limiting example, an advanced vehicle communication network may include modules for supporting audio and other information and entertainment systems, on board charging, exterior cameras, connectivity for external devices (e.g., universal serial bus connectivity) and door control (e.g., locks, windows, side-view mirrors), and automobile diagnostics, without limitation. Similar considerations arise for communication networks used in industrial controls, building operations systems, building management systems, residential utility systems, and connected lighting systems, without limitation.

To support these modules, the automotive industry relies on various communication protocols. 10SPE (i.e., 10 Mbps Single Pair Ethernet) is a network technology specification currently under development by the Institute of Electrical and Electronics Engineers (IEEE) as IEEE 802.3cg™. 10SPE may be used to provide a collision free, deterministic transmission on a multi-drop network. While the 10SPE specification provides for PHY requirements for normal operation, there are no requirements for lower power or sleep modes (low power modes, power saving modes, and sleep modes are collectively referred to herein as “sleep mode(s)”).

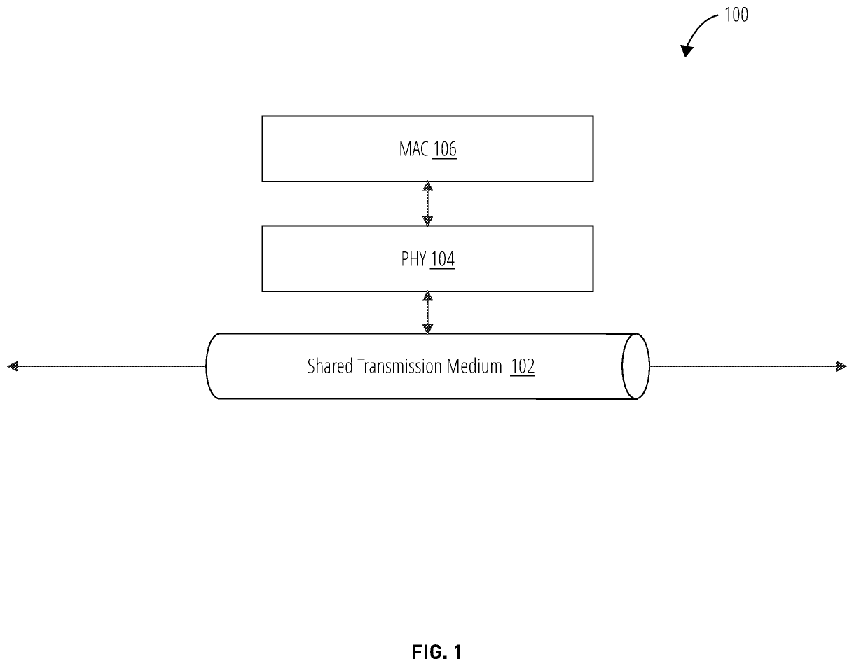

FIG. 1 shows a functional block diagram of a network segment 100 including a link layer device, MAC 106, and a physical layer (PHY) device, PHY 104. As non-limiting examples, network segment 100 may be a segment of a multi-drop network, a segment of a multi-drop sub-network, a multi-drop bus that is a segment of a mixed media network, or a combination or sub-combination thereof. As non-limiting examples, network segment 100 may be, be part of, or include one or more of a microcontroller-type embedded system, a user-type computer, a computer server, a notebook computer, a tablet, a handheld device, a mobile device, a wireless earbud device or headphone device, a wired earbud or headphone device, an appliance sub-system, lighting sub-system, sound sub-system, building control systems, residential monitoring system (e.g., for security or utility usage, without limitation)) system, elevator system or sub-system, public transit control system (e.g., for above ground train, below ground train, trolley, or bus, without limitation), an automobile system or automobile sub-system, or an industrial control system, without limitation. As a non-limiting example, PHY 104 and MAC 106 may be part of an endpoint or a switch.

PHY 104 is configured, generally, to interface with MAC 106. As non-limiting examples, PHY 104 and/or MAC 106 may be chip packages including memory and/or logic configured for carrying out all or portions of embodiments described herein. As non-limiting examples, PHY 104 and MAC 106, respectively, may be implemented as separate chip packages or circuitry (e.g., integrated circuits) in a single chip package (e.g., a system-in-a-package (SIP)).

PHY 104 is configured, generally, to interface with shared transmission medium 102, a physical medium that is a communication path for nodes that are, for example, part of network segment 100 or a network of which network segment 100 is a part, including nodes that include respective instances of PHY 104 and MAC 106. As a non-limiting example, shared transmission medium 102 may be a single twisted pair such as used for single pair Ethernet.

In some instances, it may be useful to operate network segment 100 in a sleep mode, and then transition it to a normal mode of operation in response to a control signal (e.g., a wake signal from a master node, without limitation) or in response to activity on shared transmission medium 102. As non-limiting examples, it may be desirable for a network segment 100 to be in a sleep mode while waiting for a scheduled transmit opportunity. However, due to power restrictions while in sleep mode, the amount of power available for circuitry responsible for monitoring control signals or bus activity may be severely limited.

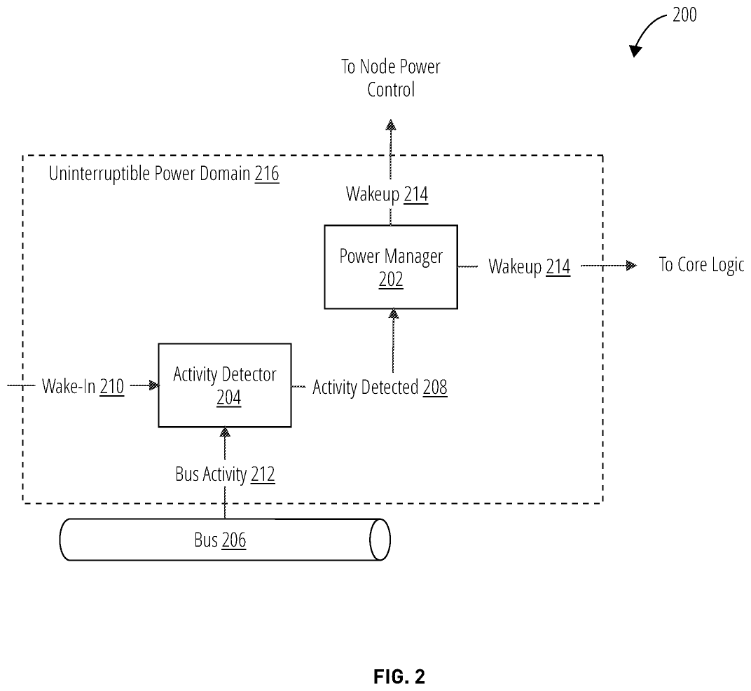

Some embodiments relate, generally, to providing for wake-up detection (i.e., detecting conditions for transitioning from a sleep mode to a normal operating mode) at a physical layer device 104 of network segment 100. FIG. 2 shows a diagram of an embodiment of a system 200 configured for various wake-up detection functions. System 200 may be, for example, implemented at a PHY 104. In various embodiments, system 200 is configured to generate a signal, wakeup 214, for indicating that a PHY, node, or more generally an endpoint should transition from a sleep mode to a power mode associated with a normal mode of operation (a normal mode of operation may also be characterized as being “awake”).

In one or more embodiments, system 200 may include modules for activity detector 204 and power manager 202. As a non-limiting example, system 200 may be configured to provide signal, wakeup 214, to a node power control responsible for supplying power to one or more components of a node, and/or to core logic of a PHY in which system 200 is implemented. For instance, PHY 104's core logic may be implemented in an interruptible power domain of PHY 104 and system 200 may be implemented in an uninterruptible power domain 216 of a PHY 104. As non-limiting examples, an interruptible power domain may be one supplied by an interruptible power source (e.g., a switched voltage regulator that is turned off during a sleep mode), and uninterruptible power domain 216 may be one supplied by a continuous power source (e.g., not interrupted during sleep mode). In one embodiment, uninterruptible power domain 216 may be powered exclusively by the continuous power source—stated another way, the circuits and digital logic in uninterruptible power domain 216 may operate exclusively on power supplied by the continuous power source. In a case of a 10SPE network used in automotive, uninterruptible power domain 216 may operate, as a non-limiting example, based on a 3.3V power supply.

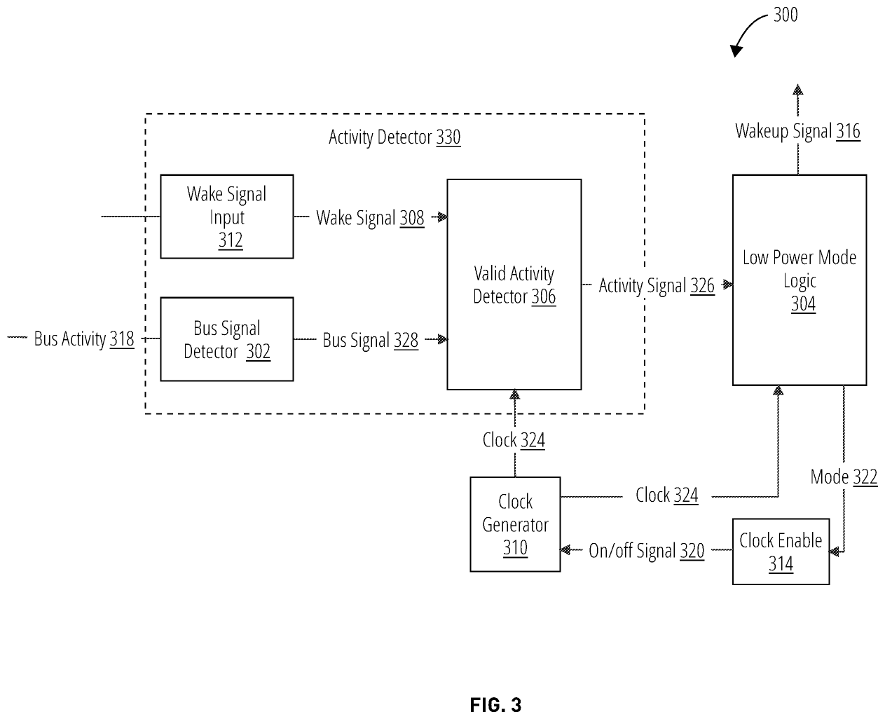

In one or more embodiments, system 200 may include activity detector 204 and power manager 202. Activity detector 204 may be configured to detect bus activity 212 on bus 206 and to detect a signal, wake-in 210 at a dedicated input pin (not shown) of system 200. Activity detector 204 may be configured to generate the signal, activity detected 208, in response to a signal, wake-in 210 and/or bus activity 212. Activity detection and related circuitry is described more fully with reference to FIGS. 3, 4, 5 and 6.

In one or more embodiments, power manager 202 may be configured to receive the signal, activity detected 208, and, in response to signal activity detected 208, generate a signal, wakeup 214. In a contemplated use case, wakeup 214 may be asserted at an interrupt at node power control or core logic.

Signals for wake-in 210 and/or bus activity 212 may be laden with noise, especially in environments that are especially prone to noise (e.g., automotive environments, commercial buildings, and lighting systems, without limitation). Indeed, not only can noise be mistaken for a valid signal, a valid signal may be mistaken for noise. So, in some instances it may be useful to provide a means for differentiating between a valid signal and an invalid signal (e.g., noise) as part of the operation of signal activity detector 204.

FIG. 3 shows a block diagram of a sleep mode controller 300 configured to differentiate between a valid and an invalid signal for wake detection purposes while performing one or more of the functions of system 200 of FIG. 2, in accordance with one or more embodiments.

In one or more embodiments, sleep mode controller 300 may include wake signal input 312 and bus signal detector 302. Wake signal input 312 is a dedicated input pin assigned to receive a wake-in signal (not shown) such as wake-in 210 of FIG. 2. Bus activity 318 may be measured at n and p terminals (not shown) coupled to respective n and p cables of the type typically used in single pair Ethernet cables.

In the embodiment of FIG. 3, wake signal input 312 is configured to propagate wake signal 308 to valid activity detector 306 in response to a received wake-in signal (e.g., wake-in 210). In other words, in such an embodiment, wake signal 308 is substantially the signal received at wake signal input 312 (e.g., wake-in 210 of FIG. 2). In some cases, it may be beneficial for wake signal input 312 to comprise a signal detector arranged to measure signal levels at wake signal input 312 and generate wake signal 308 in response to observing a signal amplitude at wake signal input 312 that is indicative of a potentially valid signal.

Bus signal detector 302 may be configured to provide bus signal 328 in response to detecting a signal level of bus activity 318 indicative of a potentially valid signal.

In one embodiment, bus signal detector 302 may include a comparator circuit that, in response to detecting that a signal level of bus activity 212 is within a specified threshold, generates the output signal, bus signal 328. As non-limiting examples, such a comparator circuit may be configured as a threshold circuit or a Schmitt trigger, without limitation.

In one embodiment, the specified threshold may be a minimum voltage value for a measured signal level of bus activity 318 to be considered potentially valid. In one embodiment, the specified threshold may be a range including an upper threshold limit and a lower threshold limit, and bus activity 318 may be determined as potentially valid in response to a measured signal level of bus activity 318 being within the upper threshold limit and the lower threshold limit.

As mentioned above, signals and/or signal levels at wake signal input 312 or bus activity 318 may be due to noise, moreover, signal levels of otherwise valid wake signal 308 and/or bus activity 318 may be affected by, as a non-limiting example, interference caused by electromagnetic emissions (EME).

In some instances it may be beneficial to consider other characteristics of a valid signal than just signal level. One such characteristic is signal duration—i.e., a period of time over which active signaling persists. Notably, time may be measured, as non-limiting examples, in units of time, units of clock cycles, or units of data.

In one or more embodiments, valid activity detector 306 may be configured to generate activity signal 326 in response to detecting that wake signal 308 or bus signal 328 is a valid signal. In one embodiment, valid activity detector 306 may be configured to detect that these signals are valid signals in response to a measured duration of wake signal 308 or bus signal 328, as the case may be, meeting a specified threshold.

In one embodiment, valid activity detector 306 may be configured to measure a signal duration for potentially valid signals detected at a wake input and/or bus by measuring a signal duration of wake signal 308 and a signal duration of bus signal 328. In one embodiment, valid activity detector 306 may include a digital counter configured to count a number of clock cycles that wake signal 308 and/or bus signal 328 are asserted. In a contemplated use case, a digital counter counts a number of clock cycles corresponding to a duration of wake signal 308 and bus signal 328. If the number of counted clock cycles exceeds a specified threshold then valid activity detector 306 is configured to generate activity signal 326.

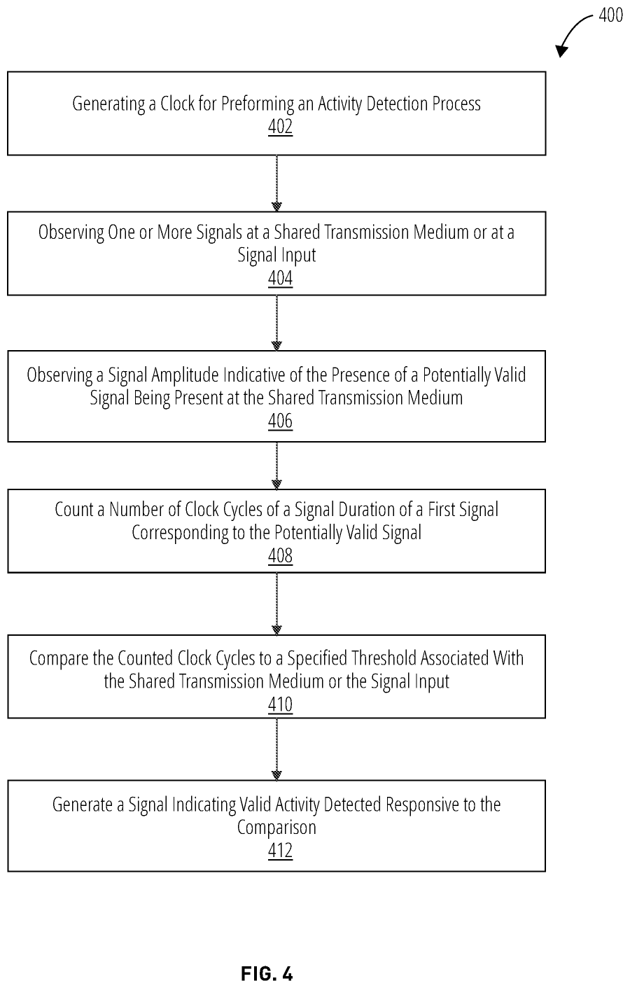

FIG. 4 shows a flowchart of an embodiment of a process 400 for detecting a valid activity. Process 400 may be used to determine if a potentially valid signal detected at wake signal input 312 is a valid signal, and used to determine if a potentially valid signal detected at bus activity 318 is a valid signal.

In operation 402, a clock is generated for performing an activity detection process, and more specifically, for performing operations 404 through 412 of process 400. As noted above, the clock may be a low frequency clock that is generated during a sleep mode.

In operation 404, process 400 observes one or more signals at a shared transmission medium or at a signal input (e.g., a dedicated input for receiving wake signals, without limitation). The one or more signals may be valid signals based on which a sleep mode should be exited, but they also may be noise.

In operation 406, process 400 observes a single amplitude indicative of the presence of one or more potentially valid signals being present at the input or at the shared transmission medium. In one embodiment, a signal of the one or more signals may be a signal propagated from the input, and another signal may be a signal generated in response to detecting activity (e.g., bus activity being above a specified level, without limitation) at the shared transmission medium. In another embodiment, instead of propagating a signal from the input, a signal may be generated in response to detecting a signal level of a potentially valid signal at the input.

In operation 408, process 400 counts a number of clock cycles of a signal duration of a first signal corresponding to the potentially valid signal. In disclosed embodiments, the first signal may be signal propagated from the input or a signal generated in response to detecting activity at a shared transmission medium. In one embodiment, the first signal comprises one or more pulses, each pulse corresponding to a duration of the potentially valid signal.

In operation 410, process 400 compares the counted number of clock cycles of operation 408 to a threshold. The threshold may be associated with the input or the shared transmission medium, as the case may be. Stated another way, a first threshold number of clock cycles may be associated with the input, a second threshold number of clock cycles may be associated with the shared transmission medium, and one of the first and the second threshold may be compared to the counted number of clock cycles. These thresholds may be associated with pulse durations for valid signals.

In operation 412, process 400 generates a signal indicating that valid activity has been detected at one of the input or the shared transmission medium. In one embodiment, the signal is generated in response to the comparison of operation 410, and more specifically, in response to determining that the counted number of clock cycles meets or exceeds the threshold.

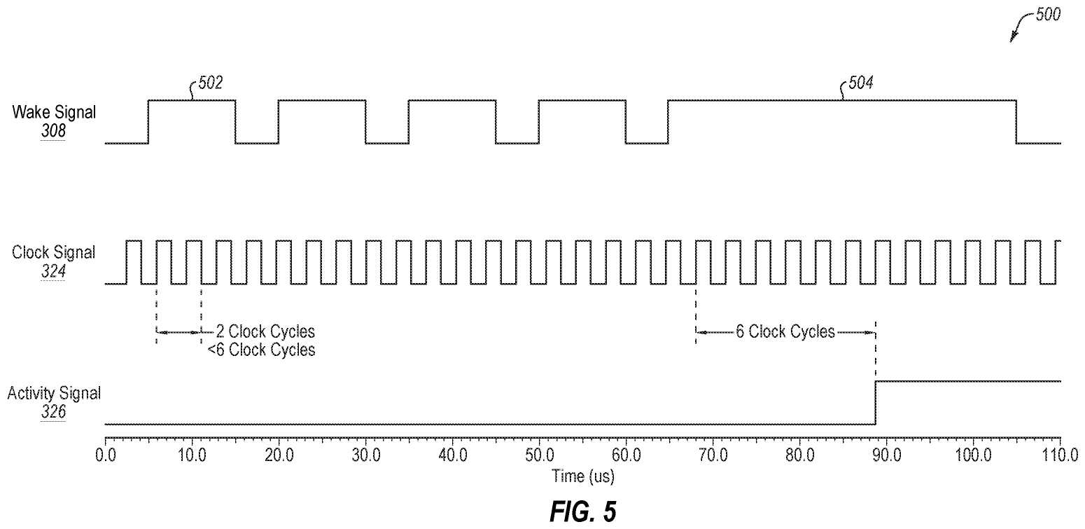

FIG. 5 shows a timing diagram 500 of an example of a valid signal detection process using a wake signal 308, in accordance with process 400. In the use case contemplated by FIG. 5, a wake signal 308 is determined to be a valid signal if a measured duration is at least six (6) clock cycles. The duration of signal pulse 502 is three clock cycles, which is less than six clock cycles and so too short, in this example, to be considered a valid signal. However, the duration of signal pulse 504 is greater than six clock cycles (here, at least ten clock cycles), which is long enough, in this example, to be considered a valid signal.

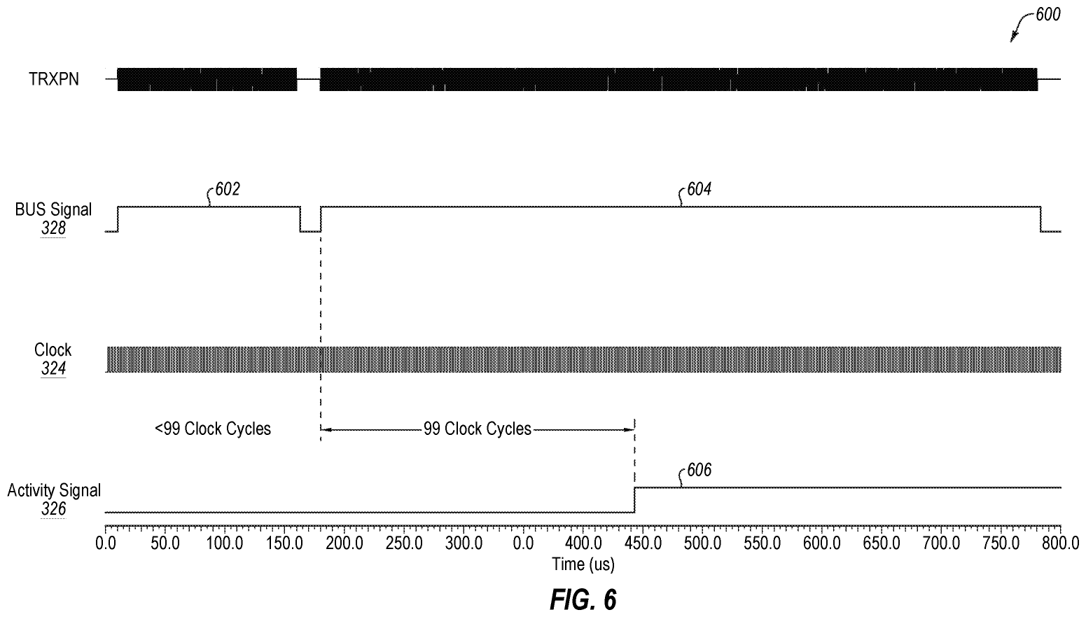

FIG. 6 shows a timing diagram 600 of an example of a valid signal detection process using a bus signal 328, in accordance with process 400. In the use case contemplated by FIG. 6, a bus signal 328 is determined to be valid if a measured duration is at least ninety nine (99) clock cycles. The duration of pulse 602 is less than 99 clock cycles, which is too short, in this example, to be considered a valid signal. However, the duration of 604 is greater than 99 clock cycles, which is long enough, in this example, to be considered a valid signal, and in response, activity signal 326 is asserted as signal pulse 606.

Turning back to FIG. 3, in some cases, operating valid activity detector 306 while in sleep mode may be too power intensive relative to the power available to uninterruptible power domain 216. So, in some embodiments, a clock 324, which is a low frequency (as described below) clock, may be included and used to clock valid activity detector 306. Moreover, in some embodiments, clock generator 310, which generates clock 324, may be operatively coupled to clock enable 314, and configured to be selectively enabled/disabled in response to on/off signal 320 generated by clock enable 314. In one or more embodiments, clock 324 may be periodically enabled by clock enable 314, and on/off signal 320 more specifically, for a measurement period and then disabled.

Clock enable 314 may be configured to provide on/off signal 320 in response to a power mode indicated by mode signal 322 (e.g., sleep mode, off mode, normal operation mode) provided by power mode logic 304. Clock enable 314 may be configured to provide on-off signal 320 in response to a mode or state indicated by mode signal 322. As a non-limiting example, if mode signal 322 indicates a normal operational mode or an off mode, then clock enable 314 may be configured to disable clock generator 310 and activity detector 330 more generally; if mode signal 322 indicates a sleep mode then clock enable 314 may be configured to enable/disable clock generator 310 and activity detector 330 more generally, according to a specified frequency and for specified measurement periods.

The frequency of occurrence and duration of measurement periods may be chosen, as a non-limiting example, based on an acceptable trade-off between sensitivity to wake conditions on the one hand and power limits of an uninterruptible power domain for a given application. As a non-limiting example, frequency of occurrence and duration of measurement may be chosen so that power consumption of clock generator 310, while enabled, is at or below a power limit of uninterruptible power domain 216.

An oscillator for clock generator 310 may be chosen, as a non-limiting example, based on an acceptable trade-off between need to perform operations described herein on the one hand and power limits of an uninterruptible power domain for a given application. As a non-limiting example, in a case where uninterruptible power domain 216 has a 35 uA max supply limit, an oscillator for clock generator 310 may be chosen that generates a signal having a frequency substantially from about 290 kHz to 330 kHz.

In response to activity signal 326, low power mode logic 304 may be configured to generate a wakeup signal 316 for, e.g., core logic and/or node power control (not shown), as non-limiting examples.

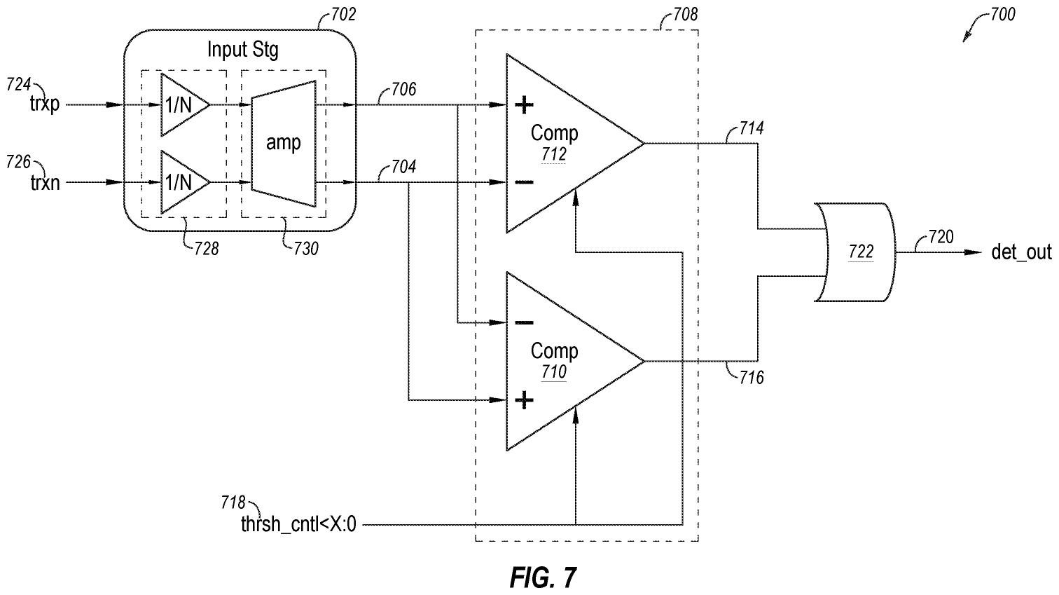

FIG. 7 shows a diagram of a circuit diagram of an embodiment of a signal detection circuit 700 that may be used to implement, for example, bus signal detector 302 of FIG. 3. In the embodiment shown in FIG. 7, signal detection circuit 700 includes a signal conditioning stage 702, a comparison stage 708, and a combining stage 722.

In one or more embodiments, signal conditioning stage 702 is configured to receive p terminal input signal 724 and n terminal input signal 726 and, in response, provide conditioned p signal 706 and conditioned n signal 704. P terminal input signal 724 and n terminal input signal 726 may be received from respective p and n terminals of a twisted pair cable used for single pair Ethernet.

In one or more embodiments, signal conditioning stage 702 includes 1/N block 728 and amp block 730. Notably, common-mode voltages during some interference cases (e.g., bulk current injection, injection molding by gas injection, without limitation) may be large enough to damage circuitry or a chip. Dividing differential and common-mode voltages should, in theory, prevent some of these interface cases. 1/N block 728 is configured to divide down a differential voltage and common-mode voltages of p terminal input signal 724 and n terminal input signal 726 by N times. As a non-limiting example, N may be chosen, at least in part, based on expected signal characteristics of a twisted pair bus to which signal detection circuit 700 is operatively coupled. Amp block 730 may be configured to receive the divided down n and p signals from 1/N block 728 and amplify an input differential voltage and to adjust an output common-mode voltage to a suitable level for comparison stage 708, and thereby obtain conditioned p signal 706 and conditioned n signal 704.

Comparison stage 708 is configured, generally, to detect differential signal amplitudes and output a detection result. Any suitable differential comparators known to those of ordinary skill in the art may be used in comparison stage 708. In one or more embodiments, comparison stage 708 may include comparator 712 and comparator 710. Comparator 712 and comparator 710 are arranged to detect positive and negative signal amplitudes, respectively. In the embodiment shown in FIG. 7, an output of signal conditioning stage 702 for conditioned p signal 706 is operatively coupled to a positive input of comparator 712 and a negative input of comparator 710. Further, an output of signal conditioning stage 702 for conditioned n signal 704 is operatively coupled to a negative input of comparator 712 and a positive input of comparator 710.

Each of comparator 712 and comparator 710 is configured to detect differential signal amplitudes responsive to threshold voltage 718. In various embodiments, threshold voltage 718 may be chosen based on a particular application. In one embodiment, a value may be chosen for threshold voltage 718 that is lower than an ideal differential signal expected for a particular application, where the difference between the threshold voltage 718 and the expected value is chosen to account for noise and/or production corners. As a non-limiting example, for a 10SPE network an expected differential signal amplitude may be substantially 1V and a threshold voltage 718 may be substantially 400 mV.

In one embodiment, threshold voltage 718 may be set based on control bits stored in control registers (not shown) of sleep mode controller 300.

As noted above, comparator 710 may be used to detect if a positive differential signal has reached the threshold or not. If it has, comparator 710 outputs a “1.” Similarly, comparator 712 may be used to detect if a negative differential signal has reached the threshold or not. If it has, comparator 712 outputs a “1.” Since a differential signal continuously toggles between its positive amplitude and negative amplitude, the two comparators 710 and 712 outputs will not necessarily be a consecutive “1.” For circuit 700 to output a consecutive “1,” combining stage 722 is provided to combine the comparators' output and send out a consecutive “1” if both positive differential signal and negative differential signal have reached the threshold.

In FIG. 7, combining stage 722 is configured to receive positive differential signal detection 714 and negative differential signal detect 716 and output combined differential signal detect 720. In one embodiment, combining stage 722 may be an OR gate that provides combined (i.e., a substantially continuous signal) differential signal detect 720 in response to positive differential signal detection 714 and negative differential signal detect 716. Stated another way, if positive differential signal detection 714 is high and/or negative differential signal detect 716 is high, then combined differential signal detect 720 will be high.

As described elsewhere in this description, combined differential signal detect 720 may be used, for example, as bus signal 328 used by valid activity detector 306 to detect if bus signal 328 is a valid signal.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting embodiments of the disclosure include:
Embodiment 1: A sleep mode controller of a physical layer of a network segment, the physical layer being an attachment layer between a single pair Ethernet bus and a portion of the network segment, the controller comprising: an activity detector configured to: observe signal levels at a bus and at a dedicated input; and provide an activity detected signal responsive to observed signal levels that exceed specified thresholds, and a power manager configured to provide a wake-up signal responsive to the activity detected signal.
Embodiment 2: The sleep mode controller according to Embodiment 1, further comprising an uninterruptible power domain that comprises the activity detector and power manager.
Embodiment 3: The sleep mode controller according to any of Embodiments 1 and 2, wherein the activity detector comprises first circuitry configured to identify one or more of a valid wake signal and a valid bus activity at the bus.
Embodiment 4: The sleep mode controller according to any of Embodiments 1 through 3, wherein the first circuitry comprises: a valid signal detector configured to provide the activity detected signal responsive to one or more of: a signal duration of the wake signal exceeding a first threshold; and a signal duration of the bus activity exceeding a second threshold.
Embodiment 5: The sleep mode controller according to any of Embodiments 1 through 4, wherein the first threshold is a first number of clock cycles and the second threshold is a second number of clock cycles, wherein the second number is different than the first number.
Embodiment 6: The sleep mode controller according to any of Embodiments 1 through 5, further comprising a bus signal detector configured to: detect bus activity having a first signal level; and provide a bus signal responsive to the detecting the bus activity.
Embodiment 7: The sleep mode controller according to any of Embodiments 1 through 6, wherein the bus signal detector comprises: a signal detection circuit configured to operably couple to a single pair bus and to detect differential signal amplitudes responsive to specified thresholds.
Embodiment 8: The sleep mode controller according to any of Embodiments 1 through 7, wherein the signal detection circuit comprises a comparison stage configured to: compare amplitudes of one or more of positive and negative signals to the specified thresholds; and provide one or more differential detection signals responsive to the comparison.
Embodiment 9: The sleep mode controller according to any of Embodiments 1 through 8, wherein the signal detection circuit further comprises a conditioning stage, wherein the conditioning stage is configured to adjust input signals to a specified level for the comparison stage.
Embodiment 10: The sleep mode controller according to any of Embodiments 1 through 9, wherein the conditioning stage is configured to adjust the input signals to the specified level by performing one or more of: dividing down a differential voltage of the input signals; dividing down common mode voltages of the input signals; amplifying the differential voltage of the input signals; and amplifying the common mode voltage of the input signals.
Embodiment 11: The sleep mode controller according to any of Embodiments 1 through 10, further comprising: a clock generator configured to generate a clock at a first frequency; and a clock enable configured to selectively enable and disable oscillation of the clock generator responsive to a power mode.
Embodiment 12: The sleep mode controller according to any of Embodiments 1 through 11, wherein the first frequency is chosen to enable operation of the valid signal detector in an uninterruptable power.
Embodiment 13: The sleep mode controller according to any of Embodiments 1 through 12, wherein the bus is a shared transmission medium is a single twisted pair Ethernet cable.
Embodiment 14: The sleep mode controller according to any of Embodiments 1 through 13, wherein the bus is a single twisted pair Ethernet cable.
Embodiment 15: A method, comprising: generating a clock; and performing an activity detection process responsive to the clock, the activity detection process comprising: observing a signal amplitude indicative of a potentially valid signal present at a shared transmission medium; counting a number of clock cycles of at least part of a signal duration of the potentially valid signal; and generating a signal indicative of valid activity responsive to detecting that the counted number of clock cycles exceeded a specified threshold.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A sleep mode controller of a physical layer of a network segment, the physical layer being an attachment layer between a single pair Ethernet bus and a portion of the network segment, the controller comprising:
an activity detector configured to:
observe signal levels at a bus and at a dedicated input; and
provide an activity detected signal responsive to observed signal levels that exceed specified thresholds, and
a power manager configured to provide a wake-up signal responsive to the activity detected signal.

2. The sleep mode controller of claim 1, further comprising an uninterruptible power domain that comprises the activity detector and power manager.

3. The sleep mode controller of claim 1, wherein the activity detector comprises first circuitry configured to identify one or more of a valid wake signal and a valid bus activity at the bus.

4. The sleep mode controller of claim 3, wherein the first circuitry comprises:
a valid signal detector configured to provide the activity detected signal responsive to one or more of:
a signal duration of the wake signal exceeding a first threshold; and
a signal duration of the bus activity exceeding a second threshold.

5. The sleep mode controller of claim 4, wherein the first threshold is a first number of clock cycles and the second threshold is a second number of clock cycles, wherein the second number is different than the first number.

6. The sleep mode controller of claim 4, further comprising a bus signal detector configured to:
detect bus activity having a first signal level; and
provide a bus signal responsive to the detecting the bus activity.

7. The sleep mode controller of claim 6, wherein the bus signal detector comprises:
a signal detection circuit configured to operably couple to a single pair bus and to detect differential signal amplitudes responsive to specified thresholds.

8. The sleep mode controller of claim 7, wherein the signal detection circuit comprises a comparison stage configured to:
compare amplitudes of one or more of positive and negative signals to the specified thresholds; and
provide one or more differential detection signals responsive to the comparison.

9. The sleep mode controller of claim 8, wherein the signal detection circuit further comprises a conditioning stage, wherein the conditioning stage is configured to adjust input signals to a specified level for the comparison stage.

10. The sleep mode controller of claim 9, wherein the conditioning stage is configured to adjust the input signals to the specified level by performing one or more of:
dividing down a differential voltage of the input signals;
dividing down common mode voltages of the input signals;
amplifying the differential voltage of the input signals; and
amplifying the common mode voltage of the input signals.

11. The sleep mode controller of claim 6, further comprising:
a clock generator configured to generate a clock at a first frequency; and
a clock enable configured to selectively enable and disable oscillation of the clock generator responsive to a power mode.

12. The sleep mode controller of claim 11, wherein the first frequency is chosen to enable operation of the valid signal detector in an uninterruptable power domain.

13. The sleep mode controller of claim 1, wherein the bus is a shared transmission medium is a single twisted pair Ethernet cable.

14. The sleep mode controller of claim 13, wherein the bus is a single twisted pair Ethernet cable.

15. A method, comprising:
generating a clock; and
performing an activity detection process responsive to the clock, the activity detection process comprising:
observing a signal amplitude indicative of a potentially valid signal present at a shared transmission medium;
counting a number of clock cycles of at least part of a signal duration of the potentially valid signal; and
generating a signal indicative of valid activity responsive to detecting that the counted number of clock cycles exceeded a specified threshold.
